(19) United States
(12) Patent Application Publication
(10) Pub. No.: US 2022/0416299 A1
(43) Pub. Date: Dec. 29, 2022

(54) Flame Retardants For Lithium Batteries

(71) Applicant: Albemarle Corporation, Charlotte, NC (US)

(72) Inventors: Zhongxin Ge, Baton Rouge, LA (US); Tse-Chong Wu, Baton Rouge, LA (US); Sascha Joerg Welz, Phoenix, AZ (US); Mark Timothy Bennett, Baton Rouge, LA (US)

(21) Appl. No.: 17/777,350

(22) PCT Filed: Nov. 18, 2020
(86) PCT No.: PCT/US2020/060940

§ 371 Date: May 17, 2022

Related U.S. Application Data
(60) Provisional application No. 62/936,692, filed on Nov. 18, 2019.

(51) Int. Cl. H01M 10/0567; H01M 10/0525; H01M 10/42; H01M 10/0568; H01M 10/0569

(52) U.S. Cl. CPC H01M 10/0567; H01M 10/0525; H01M 10/4235; H01M 10/0568; H01M 10/0569; H01M 2300/0051

(57) ABSTRACT

This invention provides nonaqueous electrolyte solutions for lithium batteries which contain one or more brominated flame retardants. The nonaqueous electrolyte solutions comprise i) a liquid electrolyte medium; ii) a lithium-containing salt; and iii) at least one brominated flame retardant. The brominated flame retardant is present in the electrolyte solution in a flame retardant amount, has a boiling point of about 60° C. or higher, and has a bromine content of about 55 wt % or more based on the weight of the brominated flame retardant.

### TECHNICAL FIELD

This invention relates to flame retardants for lithium batteries.

### BACKGROUND

One of the components impacting the safety of lithium-ion batteries is their use of flammable solvents in the lithium-containing electrolyte solutions. Inclusion of a flame retardant in the electrolyte solution is one way to mitigate the flammability of these solutions. For a flame retardant to be a suitable component of an electrolyte solution, solubility in the electrolyte is needed, along with electrochemical stability over the range of battery operation, and minimal negative effect on battery performance. Negative effects on battery performance can include reduced conductivity, and/or chemical instability to the active material.

What is desired is a flame retardant that can effectively suppress the flammability of lithium ion batteries with minimal impact to the electrochemical performance of the lithium ion battery at a reasonable cost.

### SUMMARY OF THE INVENTION

This invention provides nonaqueous electrolyte solutions for lithium batteries which contain at least one brominated flame retardant. In the presence of the brominated flame retardant(s), fires are extinguished in these nonaqueous electrolyte solutions, at least under laboratory conditions.

An embodiment of this invention is a nonaqueous electrolyte solution for a lithium battery, which solution comprises i) a liquid electrolyte medium; ii) a lithium-containing salt; and iii) at least one brominated flame retardant. The brominated flame retardant is present in the electrolyte solution in a flame retardant amount, has a boiling point of about 60° C. or higher, and has a bromine content of about 55 wt % or more, preferably about 60 wt % or more, based on the weight of the brominated flame retardant. The brominated flame retardant is not tribromoethylene or tribromoneopentyl alcohol.

Another embodiment of this invention is a nonaqueous electrolyte solution for a lithium battery, which solution comprises i) a liquid electrolyte medium; ii) a lithium-containing salt; and iii) at least one brominated flame retardant. The brominated flame retardant is selected from 1,1,2-tribromoethane, 1,1,2,2-tetrabromoethane, bromochloromethane, tribromomethane (bromoform), 1,3-dibromopropane, 2,3-dibromo-2-propenol, dibromomethane, 1,2-dibromoethane, 1,2-dibromoethylene, 1,4-dibromobutane, 1,5-dibromopentane, and 1,3-dibromobenzene.

These and other embodiments and features of this invention will be still further apparent from the ensuing description and appended claims.

### FURTHER DETAILED DESCRIPTION OF THE INVENTION

Throughout this document, the phrase “electrolyte solution” is used interchangeably with the phrase “nonaqueous electrolyte solution.”

The liquid electrolyte medium contains one or more solvents that typically form the liquid electrolyte medium for lithium electrolyte solutions used in lithium batteries, which solvents are polar and aprotic, stable to electrochemical cycling, and preferably have low viscosity. These solvents usually include noncyclic carbonic acid esters, cyclic carbonic acid esters, ethers, sulfur-containing compounds, and esters of boric acid.

The solvents that can form the liquid electrolyte medium in the practice of this invention include ethylene carbonate (1,3-dioxolan-2-one), dimethyl carbonate, ethyl methyl carbonate, diethyl carbonate, dioxolane, dimethoxy ethane (glyme), tetrahydrofuran, methanesulfonyl chloride, ethylene sulfite, 1,3-propylene glycol boric ester, and mixtures of any two or more of the foregoing.

Preferred solvents include ethylene carbonate, ethyl methyl carbonate, and mixtures thereof. More preferred are mixtures of ethylene carbonate and ethyl methyl carbonate, especially at volume ratios of ethylene carbonate:ethyl methyl carbonate ratios of about 20:80 to about 40:60, more preferably about 25:75 to about 35:65.

Suitable lithium-containing salts in the practice of this invention include lithium chloride, lithium bromide, lithium iodide, lithium perchlorate, lithium nitrate, lithium thiocyanate, lithium aluminate, lithium tetrachloroaluminate, lithium tetrafluoroaluminate, lithium tetraphenylborate, lithium tetrafluoroborate, lithium bis(oxalato)borate (LiBOB), lithium di(fluoro)(oxalato)borate, lithium hexafluorophosphate, lithium hexafluoroarsenate, lithium hexafluoroantimonate, lithium titanium oxide, lithium manganese oxide, lithium cobalt oxide (LiCoO₂), lithium nickel oxide (LiNiO₂), lithium alkyl carbonates in which the alkyl group has 1 to 6 carbon atoms, lithium methylsulfonate, lithium trifluoromethylsulfonate, lithium pentafluoroethylsulfonate, lithium pentafluorophenylsulfonate, lithium fluorosulfonate, lithium bis(trifluoromethyl sulfonyl)imide, lithium bis(pentafluoroethyl sulfonyl)imide, lithium (ethylsulfonyl)(trifluoromethylsulfonyl)imide, and mixtures of any two or more of the foregoing. Preferred lithium-containing salts include lithium hexafluorophosphate and lithium bis(oxalato)borate.

Typical concentrations for the lithium-containing salt in the electrolyte solution are in the range of about 0.1 M to about 2.5 M, preferably about 0.5 M to about 2 M, more preferably about 0.75 M to about 1.75 M, and still more preferably about 0.95 M to about 1.5 M. When more than one lithium-containing salt forms the lithium-containing electrolyte, the concentration refers to the total concentration of all of the lithium-containing salts present in the electrolyte solution.

The electrolyte solution can contain other salts in addition to lithium salts, unless such other salt(s) materially degrade either the performance of the battery for the desired application, or the flame retardancy of the electrolyte solution. Suitable electrolytes other than lithium salts include other alkali metal salts, e.g., sodium salts, potassium salts, rubidium salts, and cesium salts, and alkaline earth metal salts, e.g., magnesium salts, calcium salts, strontium salts, and barium salts. In some aspects, the salts in the non-aqueous electrolyte solution are only one or more lithium salts.

Suitable alkali metal salts that can be present in the electrolyte solution include sodium salts such as sodium chloride, sodium bromide, sodium iodide, sodium perchlorate, sodium nitrate, sodium thiocyanate, sodium aluminate, sodium tetrachloroaluminate, sodium tetrafluoroaluminate, sodium tetraphenylborate, sodium tetrafluoroborate, and sodium hexafluorophosphate; and potassium salts such as potassium chloride, potassium bromide, potassium iodide, potassium perchlorate, potassium nitrate, potassium thiocyanate, potassium aluminate, potassium tetrachloroaluminate, potassium tetrafluoroaluminate, potassium tetraphenylborate, potassium tetrafluoroborate, and potassium hexafluorophosphate.

Suitable alkaline earth metal salts that can be present in the electrolyte solution include magnesium salts such as magnesium chloride, magnesium bromide, magnesium iodide, magnesium perchlorate, magnesium nitrate, magnesium thiocyanate, magnesium aluminate, magnesium tetrachloroaluminate, magnesium tetrafluoroaluminate, magnesium tetraphenylborate, magnesium tetrafluoroborate, and magnesium hexafluorophosphate; and calcium salts such as calcium chloride, calcium bromide, calcium iodide, calcium perchlorate, calcium nitrate, calcium thiocyanate, calcium aluminate, calcium tetrachloroaluminate, calcium tetrafluoroaluminate, calcium tetraphenylborate, calcium tetrafluoroborate, and calcium hexafluorophosphate.

In the practice of this invention, the flame retardant are soluble in, or miscible with, the liquid medium of the nonaqueous electrolyte solution. Flame retardants that are in liquid form are miscible with the liquid medium of the nonaqueous electrolyte solution, where “miscible” means that the flame retardants do not form a separate phase from the electrolyte solution. More specifically, a flame retardant is miscible if it forms a single phase in a mixture of 30 wt % ethylene carbonate and 70 wt % ethyl methyl carbonate which contains 1.2 M lithium hexafluorophosphate, after 24 hours of shaking in a mechanical shaker, and no separate phase is formed after the shaking is stopped, and the flame retardant does not precipitate from, or form a suspension or slurry in, the nonaqueous electrolyte solution.

The term “soluble,” usually used for flame retardants in solid form, indicates that, once dissolved, the flame retardant does not precipitate from, or form a suspension or slurry in, the nonaqueous electrolyte solution. More specifically, a flame retardant is soluble if it dissolves in a mixture of 30 wt % ethylene carbonate and 70 wt % ethyl methyl carbonate which contains 1.2 M lithium hexafluorophosphate, after 24 hours of shaking in a mechanical shaker, if no precipitate, suspension, or slurry is formed after the shaking is stopped. It is recommended and preferred that the brominated flame retardant does not cause the precipitation of, or formation of a suspension or slurry of, any of the other components of the nonaqueous electrolyte solution.

In the practice of this invention, the brominated flame retardants generally have a bromine content of about 55 wt % or more, preferably about 60 wt % or more, based on the weight of the brominated flame retardant and a boiling point of about 60° C. or higher, preferably about 65° C. or higher, more preferably about 85° C. or higher. In some embodiments, the brominated flame retardants in the practice of this invention have a bromine content in the molecule that ranges from about 55 wt % to about 95 wt %, more preferably about 60 wt % to about 95 wt %. In some preferred embodiments, the brominated flame retardants have a bromine content in the molecule that ranges from about 75 wt % to about 95 wt %.

The boiling point for the brominated flame retardants in this invention are about 60° C. or more, preferably about 65° C. or more, more preferably about 85° C. or more, and typically range from about 60° C. to about 340° C., preferably from about 65° C. to about 325° C., more preferably from about 95° C. to about 300° C., still more preferably from about 100° C. to about 250° C. The boiling points described throughout this document are at standard temperature and pressure (standard conditions) unless otherwise stated.

In the practice of this invention, a flame retardant amount in the nonaqueous electrolyte solution means enough flame retardant is present that the solution passes the modified horizontal UL-94 test described below. The flame retardant amount is different for different brominated flame retardants, and in some embodiments is usually more than about 4 wt % flame retardant molecules, preferably about 6 wt % or more flame retardant molecules, relative to the total weight of the nonaqueous electrolyte solution. In other embodiments, the flame retardant amount is more than about 6 wt % flame retardant molecules, more than about 8 wt % flame retardant molecules, more than about 10 wt % flame retardant molecules, or more than about 15 wt % flame retardant molecules, and preferably about 8 wt % or more flame retardant molecules, about 10 wt % or more flame retardant molecules, about 15 wt % or more flame retardant molecules, about 20 wt % or more flame retardant molecules, relative to the total weight of the nonaqueous electrolyte solution.

The flame retardant amount in the nonaqueous electrolyte solution (that passes the modified horizontal UL-94 test described below) in terms of bromine content is usually about 5 wt % or more bromine (atoms), relative to the total weight of the nonaqueous electrolyte solution, and is different for different brominated flame retardants. In some embodiments, the flame retardant amount is about 6 wt % or more, preferably about 7 wt % or more, bromine (atoms), relative to the total weight of the nonaqueous electrolyte solution. In other embodiments, the flame retardant amount is about 8 wt % or more, preferably about 9 wt % or more, more preferably about 10 wt % or more, still more preferably about 12 wt % or more, bromine (atoms), relative to the total weight of the nonaqueous electrolyte solution.

The brominated flame retardants used in this invention usually have one to about eight carbon atoms, preferably one to about six carbon atoms. The brominated flame retardants typically have a molecular weight in the range of about 125 g/mol to about 350 g/mol, preferably about 150 g/mol to about 325 g/mol. The number of bromine atoms in the brominated flame retardant generally range from one to about four bromine atoms in the molecule.

In preferred embodiments, the brominated flame retardant has a boiling point in the range of 60° C. to about 340° C., preferably from about 65° C. to about 325° C., more preferably from about 95° C. to about 300° C., and a bromine content in the molecule that ranges from about 55 wt % to about 95 wt %, more preferably about 60 wt % to about 95 wt %, still more preferably about 75 wt % to about 95 wt %. In some preferred embodiments, the brominated flame retardants have a boiling point in the range of about 95° C. to about 325° C. and a bromine content in the molecule that ranges from about 75 wt % to about 95 wt %. In more preferred embodiments, the brominated flame retardant also has one to about eight carbon atoms, preferably one to about six carbon atoms, and a molecular weight in the range of about 125 g/mol to about 350 g/mol, preferably about 150 g/mol to about 325 g/mol.

In some embodiments, the flame retardant amount is more than 4 wt % relative to the total weight of the solution, and the brominated flame retardant has a boiling point of about 145° C. to about 250° C. and a bromine content of about 85 wt % or more based on the weight of the brominated flame retardant. In preferred embodiments, the flame retardant amount is about 6 wt % or more relative to the total weight of the solution, or about 5.4 wt % or more bromine (atoms), relative to the total weight of the nonaqueous electrolyte solution. Preferably, the brominated flame retardant is an aliphatic or alkenyl molecule having one or two carbon atoms and two to four bromine atoms; these brominated flame retardants typically have molecular weights of about 225 g/mol to about 375 g/mol, preferably about 245 g/mol to about 360 g/mol. More preferably, the brominated flame retardant is 1,1,2-tribromoethane, 1,1,2,2-tetrabromoethane, or bromoform (CHBr₃).

In other embodiments, the flame retardant amount is more than 6 wt % relative to the total weight of the solution, and the brominated flame retardant has a boiling point of about 150° C. to about 225° C. and a bromine content of about 75 wt % or more based on the weight of the brominated flame retardant. In preferred embodiments, the flame retardant amount is about 8 wt % or more relative to the total weight of the solution, or about 6.3 wt % or more bromine (atoms), relative to the total weight of the nonaqueous electrolyte solution. In some preferred embodiments, the brominated flame retardant has a boiling point of about 175° C. to about 215° C. Preferably, the brominated flame retardant is an aliphatic molecule having three carbon atoms and two to three bromine atoms; these brominated flame retardants typically have molecular weights of about 185 g/mol to about 225 g/mol. More preferably, the brominated flame retardant is 1,3-dibromopropane.

In still other embodiments, the flame retardant amount is more than 8 wt % relative to the total weight of the solution, and the brominated flame retardant has a boiling point of about 85° C. to about 250° C. and has a bromine content of about 65 wt % or more based on the weight of the brominated flame retardant. In preferred embodiments, the flame retardant amount is about 10 wt % or more relative to the total weight of the solution, or about 6.9 wt % or more bromine (atoms), relative to the total weight of the nonaqueous electrolyte solution. In some preferred embodiments, the brominated flame retardant has a boiling point of about 95° C. to about 250° C., more preferably about 95° C. to about 225° C. Preferably, the brominated flame retardant is an a,w-brominated aliphatic or alkenyl molecule having one to five carbon atoms and two bromine atoms, or an alkenol having three carbon atoms and two bromine atoms; these brominated flame retardants typically have molecular weights of about 165 g/mol to about 250 g/mol. More preferably, the brominated flame retardant is 2,3-dibromo-2-propen-1-ol, dibromomethane, 1,2-dibromoethane, 1,2-dibromoethylene, 1,4-dibromobutane, 1,5-dibromopentane.

In another embodiment, the flame retardant amount is more than 15 wt % relative to the total weight of the solution and the brominated flame retardant has a bromine content of about 65 wt % or more based on the weight of the brominated flame retardant. In preferred embodiments, the flame retardant amount is about 20 wt % or more relative to the total weight of the solution, or about 13.6 wt % or more bromine (atoms), relative to the total weight of the nonaqueous electrolyte solution. In some preferred embodiments, the brominated flame retardant has a boiling point of about 175° C. to about 225° C., more preferably about 200° C. to about 225° C. Preferably, the brominated flame retardant is an aromatic compound having six to twelve carbon atoms, more preferably about 6 to about 8 carbon atoms, and two or more bromine atoms attached to the aromatic ring; these brominated flame retardants typically have molecular weights of about 200 g/mol to about 250 g/mol. More preferably, the brominated flame retardant is 1,3-dibromobenzene.

Mixtures of two or more brominated flame retardants can be used in the practice of this invention. In the mixtures of two or more brominated flame retardants, the flame retardant amount is about 20 wt % or more flame retardant molecules relative to the total weight of the nonaqueous electrolyte solution, where the amount refers to the total amount of brominated flame retardants in the nonaqueous electrolyte solution. Similarly, the flame retardant amount as bromine is about 16 wt % or more bromine (atoms), relative to the total weight of the nonaqueous electrolyte solution, where the amount refers to the total amount of bromine atoms from all of the brominated flame retardants in the nonaqueous electrolyte solution. In the mixtures of brominated flame retardants, one of the components is 1,2-dibromoethane and the other component is 2,3-dibromo-2-propen-1-ol (dibromoallyl alcohol or DBAA). In the mixtures, the weight ratio of 1,2-dibromoethane to DBAA is in the range of about 1.5:1 to about 3:1, more preferably about 1.5:1 to about 2.5:1, still more preferably about 2:1 to about 2.5:1.

One or more non-brominated flame retardants can be included in the electrolyte solution, if desired. These other flame retardants are generally fluorinated cyclotriphosphinine derivatives, such as 2-phenoxy-2,4,4,6,6-pentafluoro-1,3,5,2λ5,4λ5,6λ5triazatriphosphinine and 2-ethoxy-2,4,4,6,6-pentafluoro-triazatriphosphinine. A preferred non-brominated flame retardant is 2-phenoxy-2,4,4,6,6-pentafluoro-1,3,5,2λ5,4λ5,6λ5triazatriphosphinine.

When a non-brominated flame retardant is used, the flame retardant amount is about 4 wt % or more, preferably about 6 wt % or more, flame retardant molecules relative to the total weight of the nonaqueous electrolyte solution, where the amount refers to the total amount of brominated flame retardant and non-brominated flame retardant in the nonaqueous electrolyte solution. In these mixtures of flame retardants, the brominated flame retardant is selected from 1,2-dibromoethane and 1,3-dibromopropane, and the non-brominated flame retardant is 2-phenoxy-2,4,4,6,6-pentafluoro-1,3,5,2λ5,4λ5,6λ5triazatri-phosphinine. In these mixtures, the weight ratio of 1,2-dibromoethane to 2-phenoxy-2,4,4,6,6-pentafluoro-1,3,5,2λ5,4λ5,6λ5triazatriphosphinine is about 1.5:1 to about 3:1, preferably about 2:1 to about 2.5:1, and the flame retardant amount is about 6 wt % or more flame retardant molecules relative to the total weight of the nonaqueous electrolyte solution; the amount of bromine is about 3 wt % or more, preferably about 3.5 wt % or more, bromine (atoms), relative to the total weight of the nonaqueous electrolyte solution. In another mixture, the weight ratio of 1,3-dibromopropane to 2-phenoxy-2,4,4,6,6-pentafluoro-1,3,5,2λ5,4λ5,6λ5triazatriphosphinine is about 1.5:1 to about 3:1, preferably about 2:1 to about 2.5:1, and the flame retardant amount is about 6 wt % or more flame retardant molecules relative to the total weight of the nonaqueous electrolyte solution; the amount of bromine is about 3 wt % or more, preferably about 3.25 wt % or more, bromine (atoms), relative to the total weight of the nonaqueous electrolyte solution.

In some embodiments of the invention, at least one electrochemical additive is included in the nonaqueous electrolyte solution.

In the practice of this invention, the electrochemical additives are soluble in, or miscible with, the liquid medium of the nonaqueous electrolyte solution. Electrochemical additives that are in liquid form are miscible with the liquid medium of the nonaqueous electrolyte solution, where “miscible” means that the electrochemical additives do not form a separate phase from the electrolyte solution. More specifically, an electrochemical additive is miscible if it forms a single phase in a mixture of 30 wt % ethylene carbonate and 70 wt % ethyl methyl carbonate which contains 1.2 M lithium hexafluorophosphate, after 24 hours of shaking in a mechanical shaker, and no separate phase is formed after the shaking is stopped, and the electrochemical additive does not precipitate from, or form a suspension or slurry in, the nonaqueous electrolyte solution.

The term “soluble,” usually used for electrochemical additives in solid form, indicates that, once dissolved, the electrochemical additive does not precipitate from, or form a suspension or slurry in, the nonaqueous electrolyte solution. More specifically, an electrochemical additive is soluble if it dissolves in a mixture of 30 wt % ethylene carbonate and 70 wt % ethyl methyl carbonate which contains 1.2 M lithium hexafluorophosphate, after 24 hours of shaking in a mechanical shaker, if no precipitate, suspension, or slurry is formed after the shaking is stopped. It is recommended and preferred that the brominated flame retardant does not cause the precipitation of, or formation of a suspension or slurry of, any of the other components of the nonaqueous electrolyte solution.

The brominated flame retardant, electrochemical additive, and mixtures thereof are generally stable to electrochemical cycling, and preferably have low viscosities and/or do not significantly increase the viscosity of the nonaqueous electrolyte solution.

In various embodiments, the electrochemical additive is selected from a) unsaturated cyclic carbonates containing three to about four carbon atoms, b) fluorine-containing saturated cyclic carbonates containing three to about four carbon atoms and one to about two fluorine atoms, c) tris(trihydrocarbylsilyl) phosphites containing three to about six carbon atoms, d) trihydrocarbyl phosphates containing three to about nine carbon atoms, e) cyclic sultones containing three to about four carbon atoms, f) saturated cyclic hydrocarbyl sulfites having a 5-membered ring and containing two to about four carbon atoms, g) saturated cyclic hydrocarbyl sulfates having a 5-membered ring and containing two to about four carbon atoms, h) cyclic dioxadithio polyoxide compounds having a 6-membered or 7-membered ring and containing two to about four carbon atoms, i) another lithium-containing salt, and j) mixtures of any two or more of the foregoing.

In other embodiments, the electrochemical additive is selected from a) an unsaturated cyclic carbonate in an amount of about 0.5 wt % to about 12 wt %, relative to the total weight of the nonaqueous electrolyte solution, b) a fluorine-containing saturated cyclic carbonate in an amount of about 0.5 wt % to about 8 wt %, relative to the total weight of the nonaqueous electrolyte solution, c) a tris(trihydrocarbylsilyl) phosphite in an amount of about 0.1 wt % to about 5 wt %, relative to the total weight of the nonaqueous electrolyte solution, d) a trihydrocarbyl phosphate in an amount of about 0.5 wt % to about 5 wt %, relative to the total weight of the nonaqueous electrolyte solution, e) a cyclic sultone in an amount of about 0.25 wt % to about 5 wt %, relative to the total weight of the nonaqueous electrolyte solution, f) a saturated cyclic hydrocarbyl sulfite in an amount of about 0.5 wt % to about 5 wt %, relative to the total weight of the nonaqueous electrolyte solution, g) a saturated cyclic hydrocarbyl sulfate in an amount of about 0.25 wt % to about 5 wt %, relative to the total weight of the nonaqueous electrolyte solution, h) a cyclic dioxadithio polyoxide compound in an amount of about 0.5 wt % to about 5 wt %, relative to the total weight of the nonaqueous electrolyte solution, i) another lithium-containing salt in an amount of about 0.5 wt % to about 5 wt %, relative to the total weight of the nonaqueous electrolyte solution, and j) mixtures of any two or more of the foregoing.

In some embodiments, the electrochemical additive is an unsaturated cyclic carbonate containing three to about six carbon atoms, preferably three to about four carbon atoms. Suitable unsaturated cyclic carbonates include vinylene carbonate (1,3-dioxol-2-one), 4-methyl-1,3-dioxol-2-one, and 4,5-dimethyl-1,3-dioxo1-2-one; vinylene carbonate is a preferred unsaturated cyclic carbonate. The unsaturated cyclic carbonate is preferably in an amount of about 0.5 wt % to about 12 wt %, more preferably about 0.5 wt % to about 3 wt % or about 8 wt % to about 11 wt %, relative to the total weight of the nonaqueous electrolyte solution.

When the electrochemical additive is a fluorine-containing saturated cyclic carbonate containing three to about five carbon atoms, preferably three to about four carbon atoms, and one to about four fluorine atoms, preferably one to about two fluorine atoms, suitable fluorine-containing saturated cyclic carbonates include 4-fluoro-ethylene carbonate and 4,5-difluoro-ethylene carbonate. Preferably the fluorine-containing saturated cyclic carbonate is 4-fluoro-ethylene carbonate. The fluorine-containing saturated cyclic carbonate is preferably in an amount of about 0.5 wt % to about 8 wt %, more preferably about 1.5 wt % to about 5 wt %, relative to the total weight of the nonaqueous electrolyte solution.

The tris(trihydrocarbylsilyl) phosphite electrochemical additives contain three to about nine carbon atoms, preferably about three to about six carbon atoms; the trihydrocarbylsilyl groups may be the same or different. Suitable tris(trihydrocarbylsilyl) phosphites include tri s(trimethylsilyl) phosphite, bis(trimethylsilyl)(triethylsilyl) phosphite, tris(triethylsilyl) phosphite, bis(trimethylsilyl)(triethylsilyl) phosphite, bis(trimethylsilyl)(tri-n-propylsilyl)phosphite, and tris(tri-n-propylsilyl) phosphite; tris(trimethylsilyl) phosphite is a preferred tris(trihydrocarbylsilyl) phosphite. The tris(trihydrocarbylsilyl) phosphite is preferably in an amount of about 0.1 wt % to about 5 wt %, more preferably about 0.15 wt % to about 4 wt %, even more preferably about 0.2 wt % to about 3 wt %, relative to the total weight of the nonaqueous electrolyte solution.

In some embodiments, the electrochemical additive is a trihydrocarbyl phosphate containing three to about twelve carbon atoms, preferably three to about nine carbon atoms. The hydrocarbyl groups can be saturated or unsaturated, and the hydrocarbyl groups in the trihydrocarbyl phosphate may be the same or different. Suitable trihydrocarbyl phosphates include trimethyl phosphate, triethyl phosphate, dimethyl ethyl phosphate, tri-n-propyl phosphate, triallyl phosphate, and trivinyl phosphate; triallyl phosphate is a preferred trihydrocarbyl phosphate. The trihydrocarbyl phosphate is usually in an amount of about 0.5 wt % to about 5 wt %, preferably about 1 wt % to about 5 wt %, more preferably about 2 wt % to about 4 wt %, relative to the total weight of the nonaqueous electrolyte solution.

When the electrochemical additive is a cyclic sultone containing three to about eight carbon atoms, preferably three to about four carbon atoms, suitable cyclic sultones include 1,3-propane sultone, 1,3-propene sultone, 1,3-butane sultone (5-methyl-1,2-oxathiolane 2,2-dioxide), 2,4-butane sultone (3-methyl-1,2-oxathiolane 2,2-dioxide), 1,4-butane sultone (1,2-oxathiane 2,2-dioxide), 2-hydroxy-alpha-toluenesulfonic acid sultone (3H-1,2-benzoxathiole 2,2-dioxide), and 1,8-naphthosultone; preferred cyclic sultones include 1,3-propane sultone and 1,3-propene sultone. The cyclic sultone is preferably in an amount of about 0.25 wt % to about 5 wt %, more preferably about 0.5 wt % to about 4 wt %, relative to the total weight of the nonaqueous electrolyte solution.

The saturated cyclic hydrocarbyl sulfite electrochemical additive contains two to about six carbon atoms, preferably two to about four carbon atoms, and has a 5-membered or 6-membered ring, preferably a 5-membered ring. One or more substituents can be present on the ring, such as methyl or ethyl groups, preferably one or more methyl groups, more preferably, no sub stituents are present on the ring. Suitable saturated cyclic hydrocarbyl sulfites include 1,3,2-dioxathiolane, 2-oxide (1,2-ethylene sulfite), 1,2-propanediol sulfite (1,2-propylene sulfite), 4,5-dimethyl-1,3,2-dioxathiolane 2-oxide, 1,3,2-dioxathiane 2-oxide, 4-methyl-1,3-dioxathiane, 2-oxide (1,3-butylene sulfite); preferred cyclic hydrocarbyl sulfites include 1,3,2-dioxathiolane, 2-oxide (1,2-ethylene sulfite). The cyclic hydrocarbyl sulfite is preferably in an amount of about 0.5 wt % to about 5 wt %, more preferably about 1 wt % to about 4 wt %, relative to the total weight of the nonaqueous electrolyte solution.

In some embodiments, the electrochemical additive is a saturated cyclic hydrocarbyl sulfate containing two to about six carbon atoms, preferably two to about four carbon atoms, and has a 5-membered or 6-membered ring, preferably a 5-membered ring. One or more substituents can be present on the ring, such as methyl or ethyl groups, preferably one or more methyl groups, more preferably, no substituents are present on the ring. Suitable saturated cyclic hydrocarbyl sulfates include 1,3,2-dioxathiolane 2,2-dioxide (1,2-ethylene sulfate), 1,3,2-dioxathiane 2,2-dioxide (1,3-propylene sulfate), 4-methyl-1,3,2-dioxathiane 2,2-dioxide (1,3-butylene sulfate), and 5,5-dimethyl-1,3,2-dioxathiane 2,2-dioxide. The saturated cyclic hydrocarbyl sulfate is preferably in an amount of about 0.25 wt % to about 5 wt %, more preferably about 1 wt % to about 4 wt %, relative to the total weight of the nonaqueous electrolyte solution.

When the electrochemical additive is a cyclic dioxadithio polyoxide compound, the cyclic dioxadithio polyoxide compound contains two to about six carbon atoms, preferably two to about four carbon atoms, and has 6-membered, 7-membered, or 8-membered ring. Preferably, the cyclic dioxadithio polyoxide compound contains two to about four carbon atoms, and has 6-membered or 7-membered ring. One or more substituents can be present on the ring, such as methyl or ethyl groups, preferably one or more methyl groups, more preferably, no substituents are present on the ring. Suitable cyclic dioxadithio polyoxide compounds include 1,5,2,4-dioxadithiane 2,2,4,4-tetroxide, 1,5,2,4-dioxadithiepane 2,2,4,4-tetraoxide (cyclodisone), 3-methyl-1,5,2,4-dioxadithiepane, 2,2,4,4-tetraoxide, and 1,5,2,4-dioxadithiocane, 2,2,4,4-tetraoxide; 1,5,2,4-dioxadithiane 2,2,4,4-tetroxide is preferred. The cyclic dioxadithio polyoxide compound is preferably in an amount of about 0.5 wt % to about 5 wt %, more preferably about 1 wt % to about 4 wt %, relative to the total weight of the nonaqueous electrolyte solution.

The phrases “another lithium-containing salt” and “other lithium containing salt” indicate that there are at least two lithium salts used in the preparation of the electrolyte solution. When the electrochemical additive is another lithium-containing salt, it is preferably in an amount of about 0.5 wt % to about 5 wt % relative to the total weight of the nonaqueous electrolyte solution. Suitable lithium-containing salts include all of the lithium-containing salts listed above; lithium bis(oxalato)borate is preferred.

Mixtures of any two or more of the foregoing electrochemical additives can be used, including different electrochemical additives of the same type and/or electrochemical additives of different types. When mixtures of electrochemical additives are used, the combined amount of the electrochemical additives is about 0.25 wt % to about 5 wt % relative to the total weight of the nonaqueous electrolyte solution. Mixtures of an unsaturated cyclic carbonate and a saturated cyclic hydrocarbyl sulfite or mixtures of a cyclic sultone, a tris(trihydrocarbylsilyl) phosphite, and a cyclic dioxadithio polyoxide compound are preferred.

Preferred types of electrochemical additives include saturated cyclic hydrocarbyl sulfates, cyclic sultones, tris(trihydrocarbylsilyl) phosphites, and another lithium-containing salt, especially when not used with other electrochemical additives. More preferably, the saturated cyclic hydrocarbyl sulfate is in an amount of about 1 wt % to about 4 wt %, the cyclic sultone is in an amount of about 0.5 wt % to about 4 wt %, the tris(trihydrocarbylsilyl) phosphite is in an amount of about 0.2 wt % to about 3 wt %, and another lithium-containing salt is in an amount of about 1 wt % to about 4 wt %, each relative to the total weight of the nonaqueous electrolyte solution.

In other embodiments, the electrochemical additive is selected from vinylene carbonate, 4-fluoro-ethylene carbonate, tris(trimethylsilyl)phosphite, triallyl phosphate, 1-propane-1,3-sultone, 1-propene-1,3-sultone, ethylene sulfite, 1,3,2-dioxathiolane 2,2-dioxide, 1,5,2,4-dioxadithiane 2,2,4,4-tetroxide, lithium bis(oxalato)borate, lithium hexafluorophosphate, and mixtures of any two or more of these. The electrochemical additive is preferably 1,3,2-dioxathiolane 2,2-dioxide, 1-propane-1,3-sultone, 1-propene-1,3-sultone, tris(trimethylsilyl)phosphite, or lithium bis(oxalato)borate, more preferably 1,3,2-dioxathiolane 2,2-dioxide, 1-propene-1,3-sultone, or lithium bis(oxalato)borate. More preferred electrochemical additives are 1,3,2-dioxathiolane 2,2-dioxide and lithium bis(oxalato)borate. Amounts and preferences therefor are as described above.

Mixtures of any two or more of the foregoing electrochemical additives can be used. When mixtures of electrochemical additives are used, the combined amount of the electrochemical additives is about 0.25 wt % to about 5 wt %, relative to the total weight of the nonaqueous electrolyte solution.

Additional ingredients that are often included in electrolyte solutions for lithium batteries can also be present in the electrolyte solutions of the present invention. Such additional ingredients include succinonitrile and silazane compounds such as hexamethyldisilazane. Typically, the amount of an optional ingredient is in the range of about 1 wt % to about 5 wt %, preferably about 2 wt % to about 4 wt %, relative to the total weight of the nonaqueous electrolyte solution.

Another embodiment of this invention provides a process for producing a nonaqueous electrolyte solution for a lithium battery. The process comprises combining components comprising i) a liquid electrolyte medium; ii) a lithium-containing salt; and iii) at least one brominated flame retardant, with the proviso that the brominated flame retardant is not tribromoethylene or tribromoneopentyl alcohol. Optionally, the components further comprise iv) at least one electrochemical additive as described above. The brominated flame retardant is present in the electrolyte solution in a flame retardant amount, has a boiling point of about 60° C. or higher, and has a bromine content of about 55 wt % or more, preferably about 60 wt % or more, based on the weight of the brominated flame retardant. The ingredients can be combined in any order, although it is preferable to add all of the components to the liquid electrolyte medium. Optional ingredients are also preferably added to the liquid electrolyte medium. Features of, and preferences for, the liquid electrolyte medium, lithium-containing salt, brominated flame retardant, electrochemical additive(s), and amounts of each component, are as described above.

Still another embodiment of this invention provides a process for producing a nonaqueous electrolyte solution for a lithium battery. The process comprises combining components comprising i) a liquid electrolyte medium; ii) a lithium-containing salt; and iii) at least one brominated flame retardant. The brominated flame retardant is selected from 1,1,2-tribromoethane, 1,1,2,2-tetrabromoethane, bromochloromethane, tribromomethane (bromoform), 1,3-dibromopropane, 2,3-dibromo-2-propenol, dibromomethane, 1,2-dibromoethane, 1,2-dibromoethylene, 1,4-dibromobutane, 1,5-dibromopentane, and 1,3-dibromobenzene. The ingredients can be combined in any order, although it is preferable to add all of the components to the liquid electrolyte medium. Optional ingredients are also preferably added to the liquid electrolyte medium. Features of, and preferences for, the liquid electrolyte medium, lithium-containing salt, brominated flame retardant, electrochemical additive(s), and amounts of each, are as described above.

The nonaqueous electrolyte solutions of the present invention, which contain one or more brominated flame retardants, are typically used in nonaqueous lithium batteries comprising a positive electrode, a negative electrode, and the nonaqueous electrolyte solution. A nonaqueous lithium battery can be obtained by injecting a nonaqueous electrolyte solution between the negative electrode and the positive electrode optionally having a separator therebetween.

The following examples are presented for purposes of illustration, and are not intended to impose limitations on the scope of this invention.

In Examples 1-3, a modified horizontal UL-94 test was performed. This modified horizontal UL-94 test is quite similar to known, published horizontal UL-94 tests. See in this regard, e.g., Otsuki, M. et al. “Flame-Retardant Additives for Lithium-Ion Batteries.” Lithium-Ion Batteries. Ed. M. Yoshio et al. New York, Springer, 2009, 275-289. The modified UL-94 test was as follows:
Wicks were cut from round fiberglass wick, and cut edges were made smooth, and then dust and particles were removed from the wick surface. The wicks were dried for 20 hours at 120° C. prior to testing. Wicks were 5±0.1 inch (112.7±0.25 cm) long.
Each specimen to be tested was prepared in a dry box in a 4 oz. (120 mL) glass jar, by combining the desired amount of flame retardant and, when present, electrochemical additive, with the desired amount of the plain electrolyte solution, e.g., 5 wt % of the brominated flame retardant and 95 wt % of the plain electrolyte solution, or e.g., 8 wt % of the brominated flame retardant. 2 wt % of the electrochemical additive, and 90 wt % of the plain electrolyte solution were combined to form the electrolyte solution containing the flame retardant. Prior to combination with the flame retardant, the plain electrolyte solution contained 1.2 M LiPF₆ in ethylene carbonate/ethyl methyl carbonate (wt ratio 3:7). Each wick was soaked in the electrolyte solution for 30 minutes.
Each specimen was removed from the electrolyte solution and held over the electrolyte solution until no dripping occurred, and then placed in a 4 oz. (120 mL) glass jar; the cap was closed to prevent electrolyte solution from evaporating.
The burner was ignited and adjusted to produce a blue flame 20±1 mm high.
A specimen was removed from its 4 oz. (120 mL) glass jar, and the specimen was placed on a metal support fixture in a horizontal position, secured at one end of the wick.

If an exhaust fan was running, it was shut off for the test.

The flame was at an angle of 45±2 degrees to the horizontal wick. One way to accomplish this when the burner had a burner tube was to incline the central axis of the burner tube toward an end of the specimen at an angle of 45±2 degrees from the horizontal.
The flame was applied to the free end of the specimen for 30±1 seconds without changing its position; the burner was removed after 30±1 seconds, or as soon as the combustion front on the specimen reached the 1 inch (2.54 cm) mark. If the specimen continued to burn after removal of the test flame, the time in seconds was recorded, for either the flame to extinguish or for the combustion front (flame) to travel from the. 1 inch (2.54 cm) mark to the 4 inch (1016 cm) mark.

A specimen was considered to be “not flammable” if the flame extinguished when the burner was removed. A specimen was considered to be “flame retardant” if the flame extinguished before reaching the 1 inch (2.54 cm) mark. A specimen was considered to be “self-extinguishing” if the flame went out before reaching the 4 inch (10.16 cm) mark.

Each modified horizontal UL-94 test result reported below is the average of three runs.

### EXAMPLE 1

Several nonaqueous electrolyte solutions containing mixtures of brominated flame retardants, prepared as described above, were subjected to the modified UL-94 test described above. Results are summarized in Tables 1A-1D below; as noted above, the reported numbers are an average value from three runs.

TABLE 1A

| | Flame | | | |
|---|---|---|---|---|
| | retardant | Bromine | | |
| Flame retardant | wt % | wt % | | Time to |
| (boiling point) | in soln. | in soln. | Result | extinguish |
| 1,1,2,- | 10 | 9.0 | flame retardant | 19 s |
| Tribromoethane | 8 | 7.2 | flame retardant | 23 s |
| (188° C.) | 6 | 5.4 | flame retardant | 31 s |
| | 4 | 3.6 | fail | — |
| 1,1,2,2- | 10 | 9.25 | flame retardant | 16 s |
| Tetrabromoethane | 8 | 7.4 | flame retardant | 27 s |
| (244° C.) | 6 | 5.6 | flame retardant | 41 s |
| | 4 | 3.7 | fail | — |
| Bromoform | 10 | 9.5 | flame retardant | 16 s |
| (CHBr₃) | 8 | 7.6 | flame retardant | 22 s |
| (150° C.) | 6 | 5.7 | flame retardant | 36 s |
| | 4 | 3.8 | fail | — |

TABLE 1B

| | Flame | | | |
|---|---|---|---|---|
| | retardant | Bromine | | |
| Flame retardant | wt % | wt % | | Time to |
| (boiling point) | in soln. | in soln. | Result | extinguish |
| 1,3- | 10 | 7.9 | flame retardant | 23 s |
| Dibromopropane | 8 | 6.3 | flame retardant | 30 s |
| (167° C.) | 6 | 4.7 | fail | — |

TABLE 1C

| | Flame | | | |
|---|---|---|---|---|
| | retardant | Bromine | | |
| Flame retardant | wt % | wt % | | Time to |
| (boiling point) | in soln. | in soln. | Result | extinguish |
| 2,3-Dibromo-2- | 10 | 7.4 | flame retardant | 26 s |
| propen-1-ol | 8 | 5.9 | fail | — |
| (208° C.) | | | | |
| Dibromomethane | 10 | 9.2 | flame retardant | 29 s |
| (98° C.) | 8 | 7.4 | fail | — |
| 1,2-Dibromoethane | 10 | 8.5 | flame retardant | 21 s |
| (132° C.) | 8 | 6.8 | fail | — |
| 1,2- | 10 | 8.6 | flame retardant | 29 s |
| Dibromoethylene | 8 | 6.9 | fail | — |
| (110° C.) | | | | |
| 1,4-Dibromobutane | 10 | 7.4 | flame retardant | 22 s |
| (197° C.) | 8 | 5.9 | fail | — |
| 1,5-Dibromopentane | 10 | 6.95 | flame retardant | 21 s |
| (224° C.) | 8 | 5.6 | fail | — |

TABLE 1D

| | Flame | | | |
|---|---|---|---|---|
| | retardant | Bromine | | |
| Flame retardant | wt % | wt % | | Time to |
| (boiling point) | in soln. | in soln. | Result | extinguish |
| 1,3- | 20 | 13.6 | flame retardant | 12 s |
| Dibromobenzene | 15 | 10.2 | self- | 2 min 13 s |
| (218° C.) | | | extinguishing* | |
| | 10 | 6.8 | fail | — |
| Bromochloro- | 20 | 12.4 | flame retardant | 16 s |
| methane | 10 | 6.2 | fail | — |
| (68° C.) | | | | |

*Comparative run.

### EXAMPLE 2

Nonaqueous electrolyte solutions containing mixtures of brominated flame retardants, prepared as described above, were subjected to the modified UL-94 test described above. Results are summarized in Table 2 below; as noted above, the reported numbers are an average value from three runs.

TABLE 2

| | | Flame | | | |
|---|---|---|---|---|---|
| | | retardant | Bromine | | |
| Flame retardants | A:B | wt % | wt % | | Time to |
| (boiling point) | (wt.) | in soln. | in soln. | Result | extinguish |
| A. 1,2-Dibromoethane | 7:3 | 20 | 16.3 | flame retard. | 11 s |
| (132° C.) | | | | | |
| B. 2,3-Dibromo-2- | | | | | |
| propen-1-ol (208° C.) | | | | | |

### EXAMPLE 3

Several nonaqueous electrolyte solutions containing a brominated flame retardant and a non-brominated flame retardant, prepared as described above, were subjected to the modified UL-94 test described above. Results are summarized in Table 3 below; as noted above, the reported numbers are an average value from three runs.

TABLE 3

| | | Flame | | | |
|---|---|---|---|---|---|
| | | retardant | Bromine | | |
| Flame retardants | A:B | wt % | wt % | | Time to |
| (boiling point) | (wt.) | in soln. | in soln. | Result | extinguish |
| A. 1,3-Dibromopropane (167° C.) | 7:3 | 6 | 3.3 | flame retard. | 32 s |
| B. Hishicolin ® O (194° C.) | | | | | |
| A. 1,2-Dibromoethane (132° C.) | 7:3 | 6 | 3.6 | flame retard. | 31 s |
| B. Hishicolin ® O (194° C.) | | | | | |
| A. 1,2-Dibromoethane (132° C.) | 1:1 | 4 | 1.7 | self-exting. | 66 s |
| B. Hishicolin ® O (194° C.) | | | | | |
| A. Bromoform (150° C.) | 1:1 | 4 | 1.9 | self-exting. | 95 s |
| B. Hishicolin ® O (194° C.) | | | | | |
| A. Tetrabromoethane (244° C.)¹ | 1:1 | 4 | 1.9 | self-exting. | 96 s |
| B. Hishicolin ® O (194° C.) | | | | | |
| A. Bromoform (150° C.)¹ | 7:3 | 4 | 2.7 | fail | — |
| B. Hishicolin ® O (194° C.) | | | | | |
| Hishicolin ® O (194° C.)² | — | 6 | — | flame retard. | 38 s |
| | — | 4 | — | self-exting. | 1 min 17 s |
| | — | 2 | — | fail | — |

¹Comparative run.
²All runs comparative; Hishicolin ® O is 2-phenoxy-2,4,4,6,6-pentafluoro-1,3,5,2λ5,4λ5,6λ5triazatriphosphinine (Nippon Chemical Co.).

### EXAMPLE 4

Tests of some nonaqueous electrolyte solutions containing brominated flame retardants in coin cells were also carried out. Coin cells were assembled using nonaqueous electrolyte solutions containing the desired amount of flame retardant. The coin cells were then subjected to electrochemical cycling of CCCV charging to 4.2 V at C/5, with a current cutoff of C/50 in the CV portion, and CC discharge at C/5 to 3.0 V.

One sample was a nonaqueous electrolyte solution without a flame retardant, and contained 1.2 M LiPF₆ in ethylene carbonate/ethyl methyl carbonate (wt ratio 3:7). The other samples contained the desired amount of flame retardant in the electrolyte solution. Results are summarized in Table 4 below; the error range in the Coulombic efficiencies is about ±0.5% to about ±1.0%. Results reported in Table 4 are averages from multiple cells; “multiple cells” usually means two or three cells.

TABLE 4

| | Flame | | | |
|---|---|---|---|---|
| Chemical name | retardant | Bromine | Coulombic efficiency | |
| (boiling point) | in soln. | in soln. | 1st cycle | 10th cycle |
| Electrolyte soln.* | 0 | 0 | 81.8% | 99.6% |
| 1,3-Dibromobenzene | 8 wt % | 5.4 wt % | 38.9% | 93.3% |
| (218° C.) | | | | |

*Comparative run.

Components referred to by chemical name or formula anywhere in the specification or claims hereof, whether referred to in the singular or plural, are identified as they exist prior to coming into contact with another substance referred to by chemical name or chemical type (e.g., another component, a solvent, or etc.). It matters not what chemical changes, transformations and/or reactions, if any, take place in the resulting mixture or solution as such changes, transformations, and/or reactions are the natural result of bringing the specified components together under the conditions called for pursuant to this disclosure. Thus the components are identified as ingredients to be brought together in connection with performing a desired operation or in forming a desired composition. Also, even though the claims hereinafter may refer to substances, components and/or ingredients in the present tense (“comprises”, “is”, etc.), the reference is to the substance, component or ingredient as it existed at the time just before it was first contacted, blended or mixed with one or more other substances, components and/or ingredients in accordance with the present disclosure. The fact that a substance, component or ingredient may have lost its original identity through a chemical reaction or transformation during the course of contacting, blending or mixing operations, if conducted in accordance with this disclosure and with ordinary skill of a chemist, is thus of no practical concern.

The invention may comprise, consist, or consist essentially of the materials and/or procedures recited herein.

As used herein, the term “about” modifying the quantity of an ingredient in the compositions of the invention or employed in the methods of the invention refers to variation in the numerical quantity that can occur, for example, through typical measuring and liquid handling procedures used for making concentrates or use solutions in the real world; through inadvertent error in these procedures; through differences in the manufacture, source, or purity of the ingredients employed to make the compositions or carry out the methods; and the like. The term about also encompasses amounts that differ due to different equilibrium conditions for a composition resulting from a particular initial mixture. Whether or not modified by the term “about”, the claims include equivalents to the quantities.

Except as may be expressly otherwise indicated, the article “a” or “an” if and as used herein is not intended to limit, and should not be construed as limiting, the description or a claim to a single element to which the article refers. Rather, the article “a” or “an” if and as used herein is intended to cover one or more such elements, unless the text expressly indicates otherwise.

This invention is susceptible to considerable variation in its practice. Therefore the foregoing description is not intended to limit, and should not be construed as limiting, the invention to the particular exemplifications presented hereinabove.

1. A nonaqueous electrolyte solution for a lithium battery, which solution comprises
i) a liquid electrolyte medium;
ii) a lithium-containing salt; and
iii) at least one brominated flame retardant, in a flame retardant amount, wherein
A) the brominated flame retardant has a boiling point of about 60° C. or higher and has a bromine content of about 55 wt % or more based on the weight of the brominated flame retardant, with the proviso that the brominated flame retardant is not tribromoethylene or tribromoneopentyl alcohol; or
B) the brominated flame retardant is selected from 1,1,2-tribromoethane, 1,1,2,2-tetrabromoethane, bromochloromethane, tribromomethane, 1,3-dibromopropane, 2,3-dibromo-2-propen-1-ol, dibromomethane, 1,2-dibromoethane, 1,2-dibromoethylene, 1,4-dibromobutane, 1,5-dibromopentane, and 1,3-dibromobenzene.

2. A solution as in claim 1 wherein the brominated flame retardant of A) has a boiling point of about 85° C. or higher, or wherein the brominated flame retardant has a boiling point in the range of about 65° C. to about 340° C.

3. (canceled)

4. A solution as in claim 1 wherein the brominated flame retardant is of A), and wherein
the flame retardant amount is more than 4 wt % relative to the total weight of the solution, and wherein the brominated flame retardant has a boiling point of about 145° C. to about 250° C. and has a bromine content of about 85 wt % or more based on the weight of the brominated flame retardant; or
the flame retardant amount is more than 6 wt % relative to the total weight of the solution, and wherein the brominated flame retardant has a boiling point of about 150° C. to about 225° C. and has a bromine content of about 75 wt % or more based on the weight of the brominated flame retardant or
the flame retardant amount is more than 8 wt % relative to the total weight of the solution, and wherein the brominated flame retardant has a boiling point of about 85° C. to about 250° C. and has a bromine content of about 65 wt % or more based on the weight of the brominated flame retardant; or
the flame retardant amount is more than 15 wt % relative to the total weight of the solution, and wherein the brominated flame retardant has a bromine content of about 65 wt % or more based on the weight of the brominated flame retardant.

5-7. (canceled)

8. A solution as in claim 1 wherein the brominated flame retardant is a mixture of 1,2-dibromoethane and 2,3-dibromo-2-propen-1-ol.

9. A solution as in claim 1 which also comprises 2-phenoxy-2,4,4,6,6-pentafluoro-1,3,5,2λ5,4λ5,6λ5triazatriphosphinine, wherein the brominated flame retardant is selected from 1,2-dibromoethane and 1,3-dibromopropane, with the provisos that:
A) the weight ratio of 1,2-dibromoethane to 2-phenoxy-2,4,4,6,6-pentafluoro-1,3,5,2λ5,4λ5,6λ5triazatriphosphinine is about 1.5:1 to about 3:1 and the flame retardant amount is about 6 wt % or more flame retardant molecules relative to the total weight of the nonaqueous electrolyte solution;
B) the weight ratio of 1,3-dibromopropane to 2-phenoxy-2,4,4,6,6-pentafluoro-1,3,5,2λ5,4λ5,6λ5triazatriphosphinine is about 1.5:1 to about 3:1, and the flame retardant amount is about 6 wt % or more flame retardant molecules relative to the total weight of the nonaqueous electrolyte solution.

10. A solution as in claim 1 wherein the liquid electrolyte medium is ethylene carbonate, ethyl methyl carbonate, or a mixture thereof, and/or wherein the lithium-containing salt is lithium hexafluorophosphate or lithium bis(oxalato)borate.

11. A solution as in 1 further comprising at least one electrochemical additive selected from:
a) unsaturated cyclic carbonates containing three to about six carbon atoms,
b) fluorine-containing saturated cyclic carbonates containing three to about five carbon atoms and one to about four fluorine atoms,
c) tris(trihydrocarbylsilyl) phosphites containing three to about nine carbon atoms,
d) trihydrocarbyl phosphates containing three to about twelve carbon atoms,
e) cyclic sultones containing three to about eight carbon atoms,
f) saturated cyclic hydrocarbyl sulfites having a 5-membered or 6-membered ring and containing two to about six carbon atoms,
g) saturated cyclic hydrocarbyl sulfates having a 5-membered or 6-membered ring and containing two to about six carbon atoms,
h) cyclic dioxadithio polyoxide compounds having a 6-membered, 7-membered, or 8-membered ring and containing two to about six carbon atoms,
i) another lithium-containing salt, and
j) mixtures of any two or more of the foregoing.

12. A solution as in claim 11 wherein the electrochemical additive is selected from:
a) unsaturated cyclic carbonates containing three to about four carbon atoms,
b) fluorine-containing saturated cyclic carbonates containing three to about four carbon atoms and one to about two fluorine atoms,
c) tris(trihydrocarbylsilyl) phosphites containing three to about six carbon atoms,
d) trihydrocarbyl phosphates containing three to about nine carbon atoms,
e) cyclic sultones containing three to about four carbon atoms,
f) saturated cyclic hydrocarbyl sulfites having a 5-membered ring and containing two to about four carbon atoms,
g) saturated cyclic hydrocarbyl sulfates having a 5-membered ring and containing two to about four carbon atoms,
h) cyclic dioxadithio polyoxide compounds having a 6-membered or 7-membered ring and containing two to about four carbon atoms,
i) another lithium-containing salt, and
j) mixtures of any two or more of the foregoing.

13. A solution as in claim 11 wherein the electrochemical additive is selected from:
a) an unsaturated cyclic carbonate in an amount of about 0.5 wt % to about 12 wt %, relative to the total weight of the nonaqueous electrolyte solution,
b) a fluorine-containing saturated cyclic carbonate in an amount of about 0.5 wt % to about 8 wt %, relative to the total weight of the nonaqueous electrolyte solution,
c) a tris(trihydrocarbylsilyl) phosphite in an amount of about 0.1 wt % to about 5 wt %, relative to the total weight of the nonaqueous electrolyte solution,
d) A trihydrocarbyl phosphate in an amount of about 0.5 wt % to about 5 wt %, relative to the total weight of the nonaqueous electrolyte solution,
e) a cyclic sultone in an amount of about 0.25 wt % to about 5 wt %, relative to the total weight of the nonaqueous electrolyte solution,
f) a saturated cyclic hydrocarbyl sulfite in an amount of about 0.5 wt % to about 5 wt %, relative to the total weight of the nonaqueous electrolyte solution,
g) a saturated cyclic hydrocarbyl sulfate in an amount of about 0.25 wt % to about 5 wt %, relative to the total weight of the nonaqueous electrolyte solution,
h) a cyclic dioxadithio polyoxide compound in an amount of about 0.5 wt % to about 5 wt %, relative to the total weight of the nonaqueous electrolyte solution,
i) another lithium-containing salt in an amount of about 0.5 wt % to about 5 wt %, relative to the total weight of the nonaqueous electrolyte solution, and
j) mixtures of any two or more of the foregoing.

14. A solution as in claim 11 wherein the electrochemical additive is a saturated cyclic hydrocarbyl sulfate, a cyclic sultone, a tris(trihydrocarbylsilyl) phosphite, or another lithium-containing salt.

15. A solution as in claim 11 wherein the electrochemical additive is
a saturated cyclic hydrocarbyl sulfate in an amount of about 1 wt % to about 4 wt %, a cyclic sultone in an amount of about 0.5 wt % to about 4 wt %, a tris(trihydrocarbylsilyl) phosphite in an amount of about 0.2 wt % to about 3 wt %, or another lithium-containing salt in an amount of about 1 wt % to about 4 wt %, each relative to the total weight of the nonaqueous electrolyte solution; or
1,3,2-dioxathiolane 2,2-dioxide, 1,3-propene sultone, 1,3-propane sultone, tris(trimethylsilyl)phosphite, or lithium bis(oxalato)borate.

16. (canceled)

17. A solution as in claim 15 wherein each electrochemical additive is not used with other electrochemical additives.

18. A solution as in claims 11 wherein the electrochemical additive is selected from vinylene carbonate, 4-fluoro-ethylene carbonate, tris(trimethylsilyl)phosphite, triallyl phosphate, 1-propane-1,3-sultone, 1-propene-1,3-sultone, ethylene sulfite, 1,3,2-dioxathiolane 2,2-dioxide, 1,5,2,4-dioxadithiane 2,2,4,4-tetroxide, lithium bis(oxalato)borate, and mixtures of any two or more of these.

19. A solution as in claim 18 wherein the electrochemical additive is selected from:
vinylene carbonate in an amount of about 0.5 wt % to about 3 wt %, relative to the total weight of the nonaqueous electrolyte solution;
vinylene carbonate in an amount of about 8 wt % to about 11 wt %, relative to the total weight of the nonaqueous electrolyte solution;
4-fluoro-ethylene carbonate in an amount of about 1.5 wt % to about 5 wt %, relative to the total weight of the nonaqueous electrolyte solution;
tris(trimethylsilyl)phosphite in an amount of about 0.2 wt % to about 3 wt %, relative to the total weight of the nonaqueous electrolyte solution;
triallyl phosphate in an amount of about 1 wt % to about 5 wt %, relative to the total weight of the nonaqueous electrolyte solution;
1,3-propane sultone or 1,3-propene sultone in an amount of about 0.5 wt % to about 4 wt %, relative to the total weight of the nonaqueous electrolyte solution;
1,3,2-dioxathiolane, 2-oxide in an amount of about 1 wt % to about 4 wt %, relative to the total weight of the nonaqueous electrolyte solution;
1,3,2-dioxathiolane 2,2-dioxide in an amount of about 1 wt % to about 4 wt %, relative to the total weight of the nonaqueous electrolyte solution;
1,5,2,4-dioxadithiane 2,2,4,4-tetroxide in an amount of about 1 wt % to about 4 wt %, relative to the total weight of the nonaqueous electrolyte solution;
lithium bis(oxalato)borate in an amount of about 1 wt % to about 4 wt %, relative to the total weight of the nonaqueous electrolyte solution; and
mixtures of any two or more of these.

20. A solution as in claim 18 wherein the electrochemical additive is
selected from 1-propane-1,3-sultone, 1-propene-1,3-sultone, 1,3,2-dioxathiolane 2,2-dioxide, tris(trimethylsilyl)phosphite, and lithium bis(oxalato)borate; or
selected from 1-propane-1,3-sultone in an amount of about 0.5 wt % to about 4 wt %, 1-propene-1,3-sultone in an amount of about 0.5 wt % to about 4 wt %, 1,3,2-dioxathiolane 2,2-dioxide, in an amount of about 1 wt % to about 4 wt %, and lithium bis(oxalato)borate in an amount of about 1 wt % to about 4 wt %, each relative to the total weight of the nonaqueous electrolyte solution.

21. (canceled)

22. A solution as in claim 20 wherein each electrochemical additive is not used with other electrochemical additives.

23. A nonaqueous lithium battery comprising a positive electrode, a negative electrode, and the nonaqueous electrolyte solution as in 1.

24. (canceled)

25. A solution as in claim 1 wherein
the flame retardant amount is more than 4 wt % relative to the total weight of the solution, and wherein the brominated flame retardant is selected from the group consisting of 1,1,2-tribromoethane, 1,1,2,2-tetrabromoethane, and bromoform; or
the flame retardant amount is more than 6 wt % relative to the total weight of the solution, and wherein the brominated flame retardant is 1,3-dibromopropane; or
the flame retardant amount is more than 8 wt % relative to the total weight of the solution, and wherein the brominated flame retardant is selected from the group consisting of 2,3-dibromo-2-propen-1-ol, dibromomethane, 1,2-dibromoethane, 1,2-dibromoethylene, 1,4-dibromobutane, 1,5-dibromopentane, and mixtures of any two or more of the foregoing; or
the flame retardant amount is more than 15 wt % relative to the total weight of the solution, and wherein the brominated flame retardant is 1,3-dibromobenzene.

26-28. (canceled)

29. A solution as in claim 25 wherein the nonaqueous electrolyte solution further comprises vinylene carbonate in an amount of about 8 wt % to about 11 wt %, relative to the total weight of the nonaqueous electrolyte solution.

30-31. (canceled)

32. A process for producing a nonaqueous electrolyte solution for a lithium battery, which process comprises combining components comprising:
i) a liquid electrolyte medium;
ii) a lithium-containing salt; and
iii) at least one brominated flame retardant, in a flame retardant amount, wherein
A) the brominated flame retardant has a boiling point of about 60° C. or higher and has a bromine content of about 55 wt % or more based on the weight of the brominated flame retardant, with the proviso that the brominated flame retardant is not tribromoethylene or tribromoneopentyl alcohol; or
B) the brominated flame retardant is selected from 1,1,2-tribromoethane, 1,1,2,2-tetrabromoethane, bromochloromethane, tribromomethane, 1,3-dibromopropane, 2,3 -dibromo-2-propen-1-ol, dibromomethane, 1,2-dibromoethane, 1,2-dibromoethylene, 1,4-dibromobutane, 1,5 -dibromopentane, and 1,3-dibromobenzene.

33. A process as in claim 32 wherein the components further comprise at least one electrochemical additive selected from:
a) unsaturated cyclic carbonates containing three to about six carbon atoms,
b) fluorine-containing saturated cyclic carbonates containing three to about five carbon atoms and one to about four fluorine atoms,
c) tris(trihydrocarbylsilyl) phosphites containing three to about nine carbon atoms,
d) trihydrocarbyl phosphates containing three to about twelve carbon atoms,
e) cyclic sultones containing three to about eight carbon atoms,
f) saturated cyclic hydrocarbyl sulfites having a 5-membered or 6-membered ring and containing two to about six carbon atoms,
g) saturated cyclic hydrocarbyl sulfates having a 5-membered or 6-membered ring and containing two to about six carbon atoms,
h) cyclic dioxadithio polyoxide compounds having a 6-membered, 7-membered, or 8-membered ring and containing two to about six carbon atoms,
i) another lithium-containing salt, and
j) mixtures of any two or more of the foregoing.

34. (canceled)

35. A process as in claim 32 wherein the components further comprise at least one electrochemical additive selected from vinylene carbonate, 4-fluoro-ethylene carbonate, tris(trimethylsilyl)phosphite, triallyl phosphate, 1-propane-1,3-sultone, 1-propene-1,3-sultone, ethylene sulfite, 1,3,2-dioxathiolane 2,2-dioxide, 1,5,2,4-dioxadithiane 2,2,4,4-tetroxide, lithium bis(oxalato)borate, and mixtures of any two or more of these.
